(19) United States
(12) Patent Application Publication
(10) Pub. No.: US 2010/0133924 A1
(43) Pub. Date: Jun. 3, 2010

(54) COMPACT LINEAR ACTUATOR AND METHOD OF MAKING SAME

(76) Inventors: Edward August NEFF, Cardiff, CA (US); Toan Minh Vu, San Diego, CA (US); Karl Gene Stocks, Oceanside, CA (US); David Dehe Huang, Carlsbad, CA (US); Naoyuki Okada, San Diego, CA (US); Tiep Trung Le, San Diego, CA (US); Gary Joseph Ring, Lemon Grove, CA (US); Mark Allen Cato, Escondido, CA (US); Jaime Sandoval Ruiz, San Marcos, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/622,372

(22) Filed: Nov. 19, 2009

Related U.S. Application Data
(60) Provisional application No. 61/117,047, filed on Nov. 21, 2008.

(51) Int. Cl. H02K 41/02; H02K 15/00

(52) U.S. Cl. 310/12.02; 29/596

(57) ABSTRACT

Disclosed herein are methods and apparatus for a guided single-phase or multi-phase linear motor actuator with a snap-together design. Some embodiments include the ability to monitor and/or adjust work being done, yet with a cost that is comparable to that of cams or pneumatic devices. In one embodiment, a coil is attached to a bobbin assembly that is secured behind a piston. To prevent rotation of the piston during operation, a spline bearing may be slidably fitted onto one or more grooves of a spline shaft disposed within the piston assembly. One or more cylindrical magnets surrounding the coil actuate the piston based upon the direction that current is traveling through the coil. Since the electromotive force generated is linear with respect to the spline shaft, unwanted lateral force acting upon the spline shaft can be reduced and/or eliminated.

### RELATED APPLICATIONS

This application claims priority to U.S. Provisional Patent Application Ser. No. 61/117,047, filed on Nov. 21, 2008, the contents of which are incorporated by reference herein.

### FIELD OF THE INVENTION

The invention relates to moving coil actuators and, more particularly, to compact linear actuators and methods for making same.

### BACKGROUND OF THE INVENTION

Conventional technologies in automation (such as cams or pneumatic devices) lack the flexibility and intelligence required to “know” whether a job has been done correctly or not. However, these technologies frequently have the advantage of having a low cost.

By contrast, electric linear servo motors have been developed over the years which attempt to provide the flexibility desired in the automation industry. Some linear motors, for example, attempt to monitor work being done, such as the LA series of moving coil linear motors manufactured by SMAC Corporation. These devices, however, have a cost of use in the range of thousands of dollars—a factor that is frequently five to ten times greater than the cost of cams or pneumatic devices. Thus, the widespread use of linear motors has been largely restricted by the significant costs involved.

Therefore, there is a need for a linear motor device that is flexible and possesses the ability to monitor and/or adjust work being done, yet at the same time, has a cost that is comparable to that of cams and pneumatic devices.

### SUMMARY OF THE INVENTION

Various embodiments of the present invention are therefore directed to a linear motor actuator which satisfies each of the foregoing needs. More specifically, various embodiments of the present invention are directed to a linear motor actuator which possesses increased capabilities, yet is inexpensive to utilize and/or manufacture.

According to some embodiments, costs may be controlled in a variety of ways. For example, manufacturing costs can be reduced by utilizing one set-up CNC lathe manufacturing. Assembly costs can be reduced by producing a “snap-together” device with a relatively simple assembly. The cost of parts can be reduced by utilizing a simpler design which requires fewer components within the linear motor actuator. Replacement costs can be reduced by utilizing a design which enables quick and simple modification of the actuator configuration when the customer's needs change.

In many embodiments, performance of the actuator may be comparable or exceed that of older technologies (particularly in terms of speed). Additionally, some embodiments may include a number of features (e.g., programmable positioning, speed, or force, and/or the ability to verify that one or more tasks have been successfully completed) which have great utility in automation as well as a wide range of other applications.

These and other embodiments will be more readily appreciated by persons of ordinary skill in the art with reference to the accompanying drawings and detailed description provided herein.

### BRIEF DESCRIPTION OF THE DRAWINGS

FIG. 1 is an exploded view of an exemplary single-coil linear motor actuator according to one embodiment of the present invention.

FIG. 2 is a partially exploded view of an exemplary 3-coil linear motor actuator according to one embodiment of the present invention.

FIG. 3A is a cross sectional view of an exemplary magnet housing according to one embodiment of the present invention.

FIG. 3B is a front view of the magnet housing depicted in FIG. 3A.

FIG. 3C is a cross sectional view of the magnet housing cut along lines A-A in FIG. 3B.

FIG. 3D is a cross sectional view of an exemplary magnet housing according to one embodiment of the present invention.

FIG. 3E is a front view of the magnet housing depicted in FIG. 3D.

FIG. 3F is a cross sectional view of the magnet housing cut along lines B-B in FIG. 3E.

FIG. 4A is a front view of an exemplary piston assembly according to one embodiment of the present invention.

FIG. 4B is an oblique view of the piston assembly depicted in FIG. 4A.

FIG. 4C is a side view of the piston assembly depicted in FIG. 4A.

FIG. 5A is a front view of an exemplary actuator housing according to one embodiment of the present invention.

FIG. 5B is a first cross sectional view of the actuator housing cut along lines A-A in FIG. 5A.

FIG. 5C is a second cross sectional view of the actuator housing cut along lines A-A in FIG. 5A.

FIG. 5D is a side view of the exemplary actuator housing depicted in FIG. 5A.

FIG. 6A is a perspective view of a linear motor actuator including a linear encoder feedback device according to one embodiment of the present invention.

FIG. 6B is a perspective view of the linear motor actuator illustrated in FIG. 6A.

FIG. 6C is a side view of the linear motor actuator illustrated in FIG. 6A.

FIG. 6D is a top view of the linear motor actuator illustrated in FIG. 6A.

FIG. 7 is a table illustrating results of a force repeatability test conducted on a linear motor actuator according to one embodiment of the present invention.

FIG. 8 is a graph illustrating results of a heat test conducted on a linear motor actuator according to one embodiment of the present invention.

FIG. 9 is a graph illustrating results of a force resolution test conducted on a linear motor actuator according to one embodiment of the present invention.

FIG. 10 is a graph illustrating the results of a friction test conducted on a linear motor actuator according to one embodiment of the present invention.

### DETAILED DESCRIPTION OF THE EXEMPLARY EMBODIMENTS

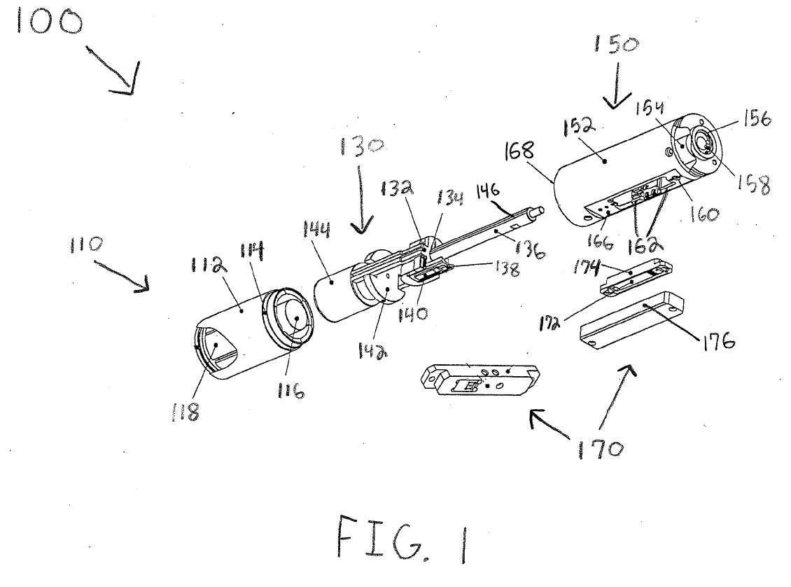

FIG. 1 is an exploded view of a single-coil linear motor actuator 100 according to one embodiment of the present invention. As shown by FIG. 1, the actuator 100 may include four components: a main housing assembly 150 (including main housing 152, spline bearing 156, and spline shaft housing 158); a piston assembly 130 (including coil 144, spline shaft 136, and linear encoder scale 140); an encoder assembly 170 (including encoder housing 172 and linear encoder 174); and a magnet housing assembly 110 (including magnet housing 112, one or more magnets 118, and center pole 116).

In some embodiments, all manufactured parts can be machined on a CNC lathe such as the Hardinge model RS51MSY. Each part can be made in a single operation on the lathe, thereby reducing and/or eliminating the need for secondary operations. These secondary operations present additional costs and may also reduce quality by increasing dimensional variation.

In some embodiments, the components of the actuator 100 may be manufactured from aluminum or steel bars. Note, however, that a myriad of other materials may be used according to the scope of the present invention. In one embodiment, the CNC lathe has the ability to machine both ends of a component (e.g., via sub-spindle transfer) as well as the ability to do mill work.

In some embodiments, the actuator 100 may include a “snap-together” design, requiring no adjustment to part location during assembly of the actuator 100. A snap-together design may thus ensure quality as well as result in a low assembly cost. With respect to the embodiment depicted by FIG. 1, it is worth noting that in one-hundred set trials, assembly times of under ten minutes have repeatedly been attained, with no performance or structural problems discovered upon further testing of the actuators 100.

In some embodiments, a snap-together actuator 100 may be achieved by keying one or more dimensions to a basic datum located on the main housing assembly 150. The datum may consist of a precisely machined flat surface 166 and an edge perpendicular to this surface 162 as shown, for example, in FIG. 1. Additional features on this housing may include a front bore 154 and a bearing centering hole 160.

In some embodiments, the flat surface 166 may be positioned flat within a specified tolerance of 10 microns, while the edge 162 may be kept perpendicular to the flat surface 166, also within a tolerance of 10 microns. The bore 154 may be held within 10 microns of the called out diameter and positioned parallel to datum components within a tolerance of 25 microns. The bore center may be kept within 20 microns to its called out dimension to the flat surface 166, while the rear bore 168 of the main housing assembly 150 may be concentric with the front bore 154 within a tolerance of 25 microns.

In some embodiments, a spline shaft housing 158 within the main housing assembly 150 may be used to house the spline shaft 136 and a spline bearing 156 which can be used to prevent the spline shaft 136 from rotating. In one embodiment, the spline bearing 156 may include a linear guide assembly manufactured by IKO Inc. (#MAG8C1THS2/N). Note, however, that a myriad of other structures/guide assemblies may be utilized according to the scope of the present invention.

In some embodiments, the linear guide assembly may be positioned within the front bore 154 by a locating pin that is guided through the main housing 152. This can ensure that a recirculating ball track associated with the spline bearing 156 remains parallel to the flat surface 166 within a specified tolerance range (e.g., within 20 microns over its length).

As shown by FIG. 1, the piston assembly 130 of the linear motor actuator 100 may include a piston 132, a piston shaft bore 134, an encoder scale surface 138, a spline shaft 136, and a DC coil 144. The piston assembly 130 may be precisely manufactured in a single set-up on the lathe, thereby reducing costs and increasing quality of performance.

In addition, the encoder scale surface 138 may be machined and positioned flat to itself within 10 microns over its length. The piston shaft bore 134 may be held to a variance of 10 microns in diameter and include a center that is kept within a tolerance of 20 microns to the encoder scale surface 138. The spline shaft 136 may be located in the piston shaft bore 136 and locked in place using a fixture that locates one or more shaft grooves 146 in an orientation that is parallel to the encoder scale surface 138 within 20 microns.

The magnet housing assembly 110 may also include a magnet housing 112, one or more magnets 118, and a center pole 116. According to one embodiment, the magnet housing 112 may include a pilot diameter 114 which guides off the rear bore 168 of the main housing 152 in order to ensure a tight relationship of the bore 168 to the main housing 152.

The center pole 116 may also include a pilot diameter for precisely locating it to the magnet housing 112. This can ensure that the center pole 116 is centered within the magnet housing 112 within a specific tolerance (for example, within a range of +/−20 microns). In some embodiments, the outside and inside diameters of the center pole 116 of the magnet housing 112 may be held to the center of the front bore 154 and/or the rear bore 168 (for example, within a range of +/−40 microns).

As shown by FIG. 1, the encoder assembly 170 may include an encoder housing 172 and a linear encoder 174 located within an encoder mounting bracket 176. The encoder assembly 170 may also include a reference edge and flat that locates it to the datum locations within a specified variance in each of the x, y, and z directions (e.g., +/−20 microns).

When the piston assembly 130 is placed into the main housing 152, the piston assembly 130 may be located by the spline shaft 136 following the spline bearing tracks. This can result in tight tolerance stack-ups for one or more variables related to actuator assembly.

The linear encoder scale 140 and the reader head of the linear encoder 174 may be separated at a distance of +/−40 microns (e.g., centered and positioned at approximately 40% of specified tolerance according to some embodiments). Additionally, both the gaps between the coil 144 and the center pole 116 and the gaps between the coil 144 and the magnets 118 may be held to +/−50 microns. In one embodiment, the gap may measure approximately 600 microns so the tolerance fluctuation may take up only ⅙ of the range specified.

Thus, by holding close tolerances and keeping the number of parts to a minimum, a snap together design with high reliability may be achieved. Sample testing has demonstrated that the actuator 100 can be built holding tolerances to one-third of the totals specified. Life testing has indicated that such actuators 100 can exceed 100,000,000 cycles without structural or operational failure.

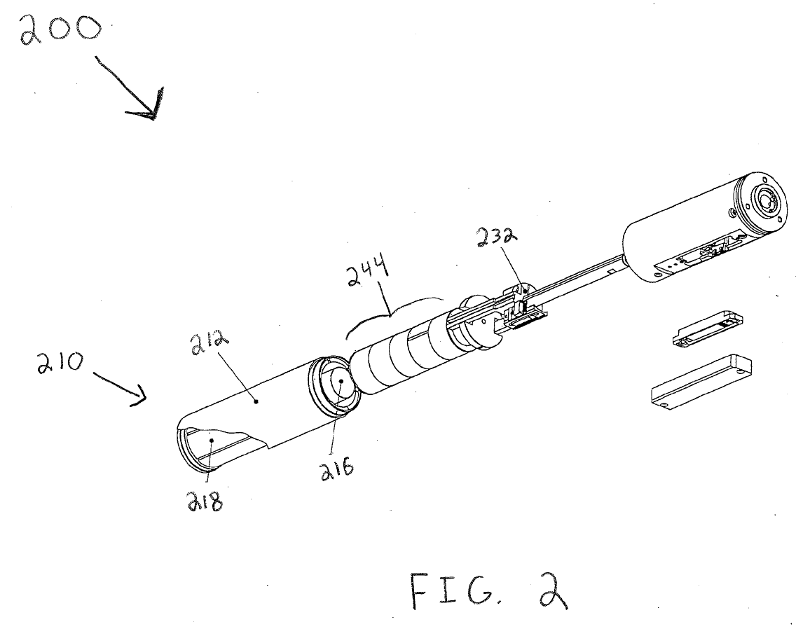

In some embodiments, stroke variation and encoder resolution may be easily adjusted, thereby reducing costs associated with reconfiguring and/or replacing the actuator. Where stroke is a function of three assemblies (the magnet housing assembly 110, the piston assembly 130, and the main housing assembly 150) a replaceable magnet housing assembly 110 may be used to increase the length of the stroke, yet without requiring replacement of more expensive components that are serviceable in all stroke variations (e.g., the piston assembly 130 or the main housing assembly 150). For example, the magnet housing assembly 110 (as depicted in FIG. 1) may be replaced with a more elongated magnet housing assembly 210 (as depicted in FIG. 2), thereby enabling a longer actuator stroke.

By providing a slot between the coil 144 and the front of the piston 132 that is long enough to cover a stroke of a specified maximum range, the piston 132 may be serviceable to cover all stroke variations. Note that the main housing assembly 150 may also be designed to be long enough to cover all stroke variations. In this manner, when the length of the stroke of the actuator requires modification, fewer components may need to be replaced. This design may also serve to reduce the number and/or variety of parts required to be stocked as well as expedite delivery of actuator components.

The linear motor actuator 100 may also be operable in a 3-coil, multi-pole configuration. For example, FIG. 2 is a partially exploded view of a 3-coil linear motor actuator 200 according to one embodiment of the present invention. As shown by FIG. 2, the 3-coil linear motor actuator 200 may contain a longer magnet housing 212 including a separate set of magnets 218 and center pole 216, as well as a piston 232 including a 3-coil assembly. The magnets 218 within the magnet housing 212 may be alternately magnetized throughout the housing 212 (e.g., NS, SN, etc). Persons skilled in the art will recognize that the magnet housing 212 and piston 232 may be implemented using standard machining processes.

Note that the exemplary configurations of actuators 100 and 200 may be utilized in a wide range of applications. For example, the single pole actuator 100 depicted in FIG. 1 may be utilized for short stroke, high speed, and lower cost applications, while the 3-coil actuator 200 depicted in FIG. 2 may be more appropriate for longer strokes involving higher forces. Myriad other applications for actuators 100 and 200 may also possible according to the scope of the present invention.

In addition, the actuator 100, 200 may include a number of programmable modes for adjusting, for example, position, force, and speed. Additionally, encoder feedback can be matched with position enabling the verification of work done by checking position of the piston 132, 232 during the stroke.

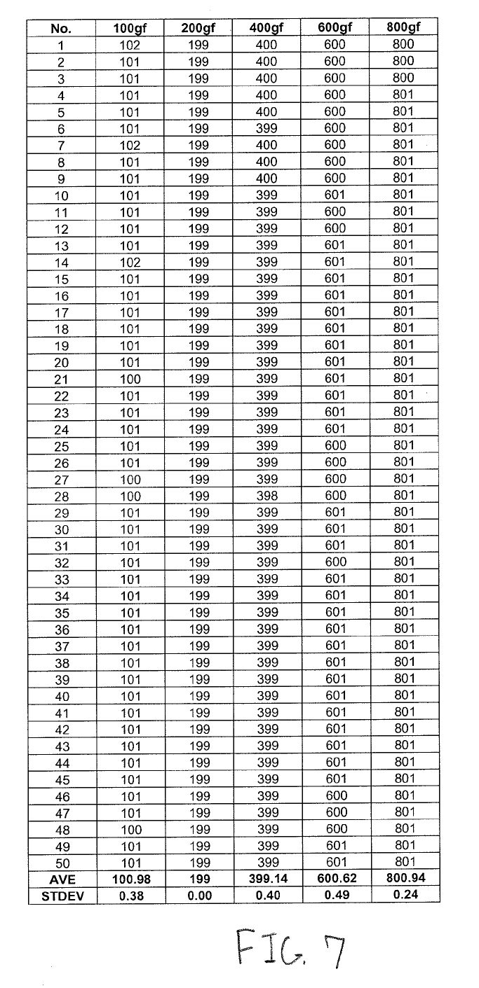

In some embodiments, (such as the embodiments depicted in FIG. 1. and FIG. 2), the coil or coils 144, 244 may surround a centered linear guide. This can remove any moment on the guide and improve force repeatability, which is very useful in precise force applications such as small electronic parts assembly and precision glass scoring. Tests have indicated a repeatability of less than 0.0005N over a force range from 0.1N to 8N (as described in FIG. 7 and the corresponding description below, for example).

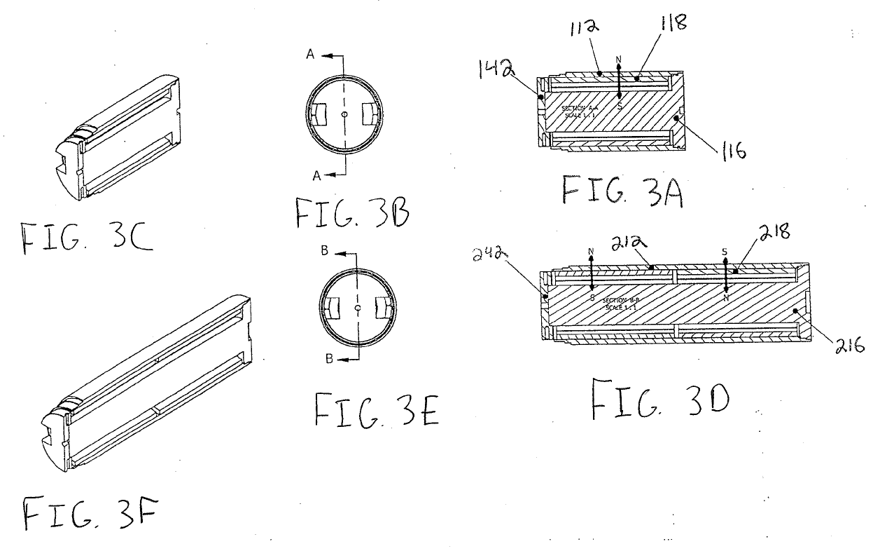

FIGS. 3A-3F depict exemplary magnet housings 112, 212 according to embodiments of the present invention. FIG. 3A-3C depict a magnet housing 112 for a single-pole, single coil linear actuator, while FIG. 3D-3F depict a magnet housing 212 for a multi-pole, 3 coil linear actuator.

As shown in the exemplary magnet housings 112 and 212 of FIGS. 3A and 3D, respectively, end plate 142, 242 may be disposed at one end of the magnet housing 112, 212. The end plate 142, 242 may be at least partially secured in place by being configured to attach to center pole 116, 216 running perpendicular to the end plate 142, 242 and through the center of the magnet housing 112, 212. Note that while the end plate 142, 242 may be shaped as shown in FIGS. 3A, 3C, 3D, and 3F, a wide variety of shapes for the end plate 142, 242 may be utilized according to the scope of the present invention.

In some embodiments, the magnet housing 112, 212 may include one or more magnets 118, 218 (e.g., substantially cylindrical magnets or circular magnet segments) in order to provide the magnetic field necessary to move the piston 132, 232 in a linear direction. The one or more magnets 118, 218 may be easily fastened inside the magnet housing 112, 212 during manufacturing with various adhesives or screws. Further, the center pole 116, 216 may be threaded and screwed into one end of the magnet housing 112, 212.

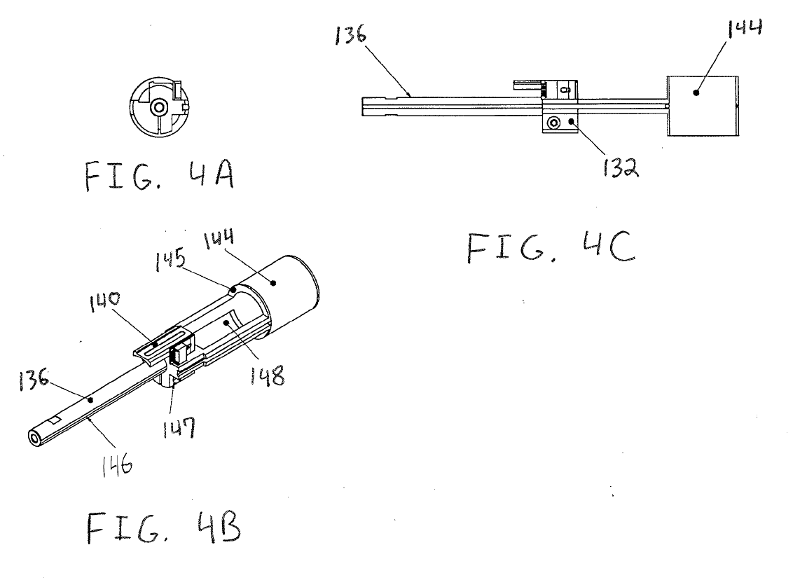

FIGS. 4A-4C show various angles of an exemplary piston assembly 132 according to one embodiment of the present invention. The piston assembly 132, including bobbin 145, may be formed as a single, unitary piece. As an exemplary advantage, a single, unitary piece can make construction of the actuator 100, 200 less complicated and quicker to assemble because there are fewer pieces. Moreover, using a single unitary piece can be more cost effective, as a single piece can be less costly to manufacture than multiple separate pieces. A single, unitary piece can also weigh less than a multi-piece piston bobbin assembly since such an assembly may require additional fasteners or hardware to attach the various pieces together.

Further to FIGS. 3A-3F and FIGS. 4A-4C, a cutout 148 can be used to restrain the end plate 142, 242 from rotating when the piston assembly 130 is slidably coupled to the magnet housing 112. The end plate 142, 242 may be laterally fixed, as shown in FIGS. 3A-3D, yet allow lateral movement of the piston assembly 130 along the full range of the cutout 148 relative to the magnet housing 112.

In some embodiments, a shaft lock 147 may be used to allow easy interchangeability of various types of spline shafts 136 depending on the particular application of the actuator 100, 200. The spline shaft 136 may include a set of one or more grooves 146 which correspond to a shape of a bearing 156 in order to avoid undesired rotation of the shaft 136.

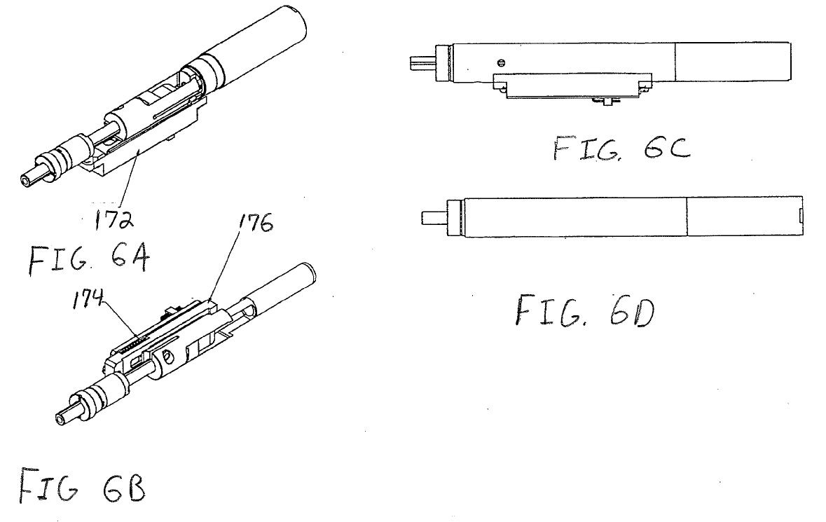

In addition, a linear encoder scale 140 may be mapped on the piston assembly 130 which can be read by an optical linear encoder 174 (as discussed below with respect to FIG. 6) in order to determine the current location of and/or how far the piston assembly 130 has moved. In doing so, the current location of the piston assembly 130 and/or other positional information may be provided as feedback to an electronic controller (not shown).

In accordance with various embodiments, the piston assembly 130 may be formed as a single integral piece. In one embodiment, a piston and double bobbin section can be formed through an extrusion and machining process. In this regard, the design and manufacture of linear actuators 100, 200 in accordance with various embodiments can be flexible, since changing from one configuration to another does not require significant tooling or equipment changes.

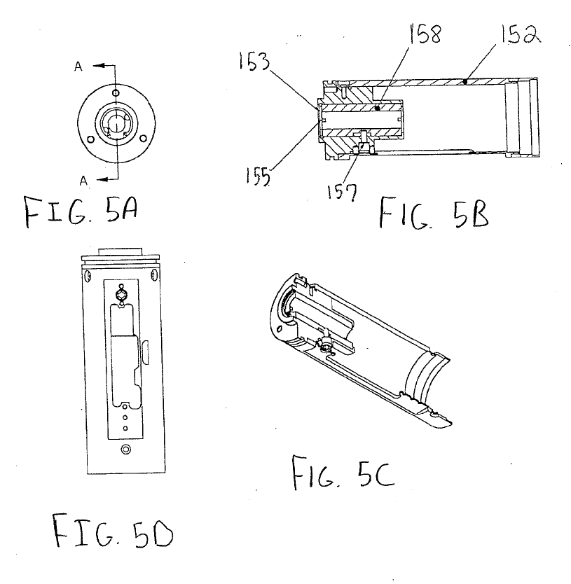

FIGS. 5A-5D show various views of a main housing assembly 150 for a linear motor actuator 100, 200 according to one embodiment of the present invention. As shown in FIGS. 5A-5D, the main housing assembly 150 may include a main housing 152, a retainer ring 153, a spline shaft housing 158, a spline shaft location feature 157, and a spring washer 155.

Further to FIGS. 5A-5D, the spline shaft housing 158 may house a spline bearing 156 that guides the spline shaft 136 and is shaped to correspond with the grooves 146 of the shaft 136, thereby mitigating undesired rotation of the shaft 136. A retainer ring 153 may screw, or otherwise fasten, to the main housing assembly 150 with a pre-specified torque in such a manner as to lock the bearing 156 in place so that it cannot move axially.

A spline bearing location feature 157 of the housing assembly 150 may be used to align the bearing 156 before it is locked in place with the retainer ring 153. According to one embodiment, a spring washer 155 may be set between the bearing 156 and the retainer ring 153. While the bearing 156 and the retainer ring 153 are illustrated as separate parts in FIG. 5, one of ordinary skill in the art will recognize that these parts can be machined together as a single component that is capable of performing the functions of both the bearing 156 and the retainer ring 153.

FIGS. 6A-6D show various views of an actuator 100, 200 with the linear encoder assembly 170 attached thereto, according to embodiments of the present invention. As shown by FIGS. 6A-6D, the linear encoder assembly 170 may include a linear encoder housing 172, a linear encoder 174, and a linear encoder bracket 176. As stated above, the linear encoder 174 may be used to track the linear motion of the piston 132, and thus the shaft 136, of a linear motor actuator 100, 200. In some embodiments, the linear encoder 174 can send information regarding the current position and/or movement of the piston 132 to an electronic controller (not shown).

The linear encoder 174 may be fastened to the actuator 100, 200 at the main housing 152 using a linear encoder bracket 176, for example. Through an opening in the main housing 152, a cable (not shown) can access the piston assembly 130. The linear encoder bracket 176 may include a substantially flat surface, and can be securely fastened to the main housing 152, using screws, for example. The bottom of the linear encoder bracket 176 may be shaped to correspond to the substantially flat upper surface of the linear encoder 174 and/or other circuit components. The linear encoder 174 and/or other circuit components may be held flush against the linear encoder bracket 176 while an epoxy or other adhesive, for example, is introduced around the linear encoder 174 and the other circuit components such that the linear encoder 174 is flatly secured to the linear encoder bracket 176. By securing the top of the linear encoder 174 flatly to the linear encoder bracket 176, the linear encoder 174 and/or other circuit components are not subjected to any compression due to their own weight, which can cause the linear encoder 176 to generate inaccurate readings.

According to some embodiments, the linear encoder 174 and the linear encoder bracket 176 may be substantially encased in a linear encoder housing 172, for added protection. The linear encoding housing 172 can be fastened to the main housing 152 of the actuator 100, 200 using screws, for example.

Note that the actuators 100, 200 described herein can be manufactured and assembled quickly and cost effectively. Further, the actuators 100, 200 may be manufactured to be relatively small, lightweight, and compact. Optionally, an optical linear encoder assembly 170 can provide monitoring and control over 100% of movement affected by actuators 100, 200. Further, the individual design of the main housing assembly 150, the magnet housing assembly 110, and the piston assembly 130 provides flexibility and easy reconfigurability during manufacturing so that various actuator configurations can be produced to conform to the specifications of a particular project.

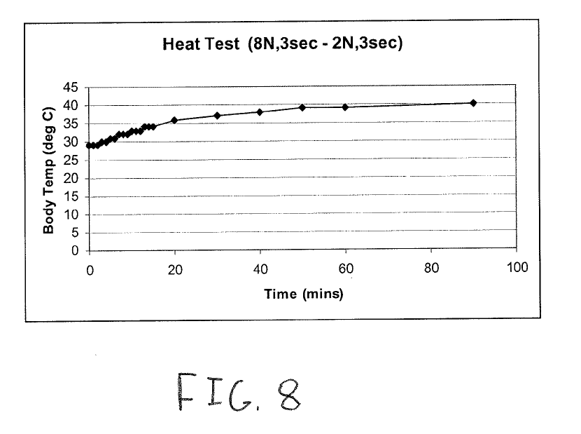

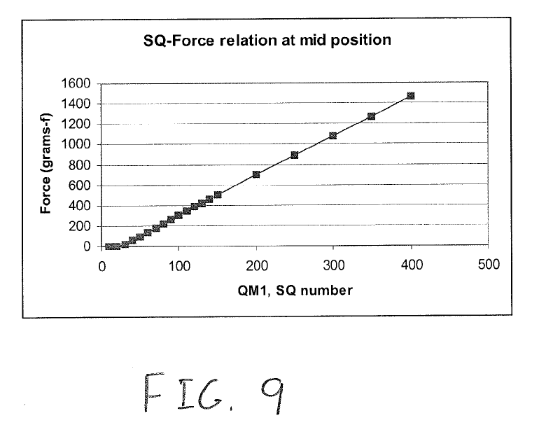

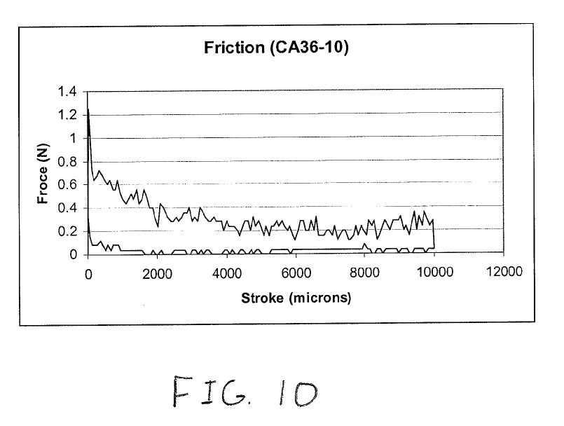

Test results for various actuators have been provided below with reference to FIGS. 7-10. The tests were conducted on CAL36-010-51-FB-MODJ42, which has a coil resistance of 35.7 ohms, a stroke of 10.4 mm, a moving mass of 50 grams, a total mass of 0.42 kg, and peak forces of 14N when retracted, 15N when mid-positioned, and 14N when extended. Force repeatability, heat, force resolution, and friction were each examined. The results of these tests are depicted in FIGS. 7, 8, 9, and 10, respectively.

The configuration for each of the respective tests is now described. In the force repeatability test, the unit was placed in the horizontal position. The shaft was configured to push the load cell for five seconds, and then release the force for five seconds.

In the heat test, the CAL36 was placed in the horizontal direction. The unit was configured to push 8N for three seconds, and then 2N for three seconds. The process was then repeated accordingly. The temperature change at the back-end of the CAL36 was monitored.

With respect to the force resolution test, in order to have less than five grams force resolution in QM1 mode, the LAC-1 controller was modified. The achieved force resolution was approximately four grams.

For the friction test, the unit was placed horizontally. The shaft was configured to move forward and backward, with the current monitored. Since the shaft attracts the magnetic field, the relatively high force is seen at the beginning of movement. The friction was approximately 0.3N.

While various embodiments of the present invention have been described above, it should be understood that they have been presented by way of example only, and not of limitation Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A linear motor actuator, comprising:
a piston assembly comprising a spline shaft, a shaft housing adapted to receive the spline shaft, and a bobbin attached to the shaft housing;
a first housing assembly comprising one or more magnets for actuating the piston assembly, wherein the first housing assembly is adapted to receive a portion of the piston assembly;
a second housing assembly adapted to connect to the first housing assembly, wherein the second housing assembly comprises a datum for enabling the connection of at least one of the piston assembly, the first housing assembly, the second housing assembly, and an encoder assembly within a predetermined tolerance; and
the encoder assembly adapted to connect to the second housing, wherein the encoder assembly is adapted to receive an encoder for determining the position of the piston assembly.

2. The linear motor actuator of claim 1, wherein each of the piston assembly, the first housing assembly, the second housing assembly, and the encoder assembly are machined on a lathe.

3. The linear motor actuator of claim 1, wherein the datum comprises a surface and a reference edge, wherein the surface is approximately flat within a first predetermined tolerance, and wherein the reference edge is approximately perpendicular to the surface within a second predetermined tolerance.

4. The linear motor actuator of claim 3, wherein the second housing assembly comprises a front bore adapted to support an annular spline bearing, and wherein the spline bearing is adapted to interface with the spline shaft along at least one groove formed within the spline shaft.

5. The linear motor actuator of claim 4, wherein the front bore comprises a predetermined diameter.

6. The linear motor actuator of claim 5, wherein the front bore is situated approximately parallel to the surface and reference edge within a third predetermined tolerance.

7. The linear motor actuator of claim 6, wherein the second housing assembly further comprises a rear bore adapted to receive a portion of the piston assembly.

8. The linear motor actuator of claim 7, wherein the rear bore is approximately concentric with the front bore within a fourth predetermined tolerance.

9. The linear motor actuator of claim 4, wherein the spline bearing comprises a linear guide assembly that is positioned within the front bore by a locating pin that is guided through the second housing assembly.

10. The linear motor actuator of claim 1, wherein the piston assembly comprises an encoder scale surface adapted to receive an encoder scale, wherein the encoder is adapted to read the encoder scale in order to determine the position of the piston assembly.

11. The linear motor actuator of claim 10, wherein the encoder scale surface comprises a surface that is approximately flat within a fifth predetermined tolerance.

12. The linear motor actuator of claim 1, wherein the shaft housing comprises a bore adapted to receive the spline shaft, wherein the bore comprises a predetermined diameter.

13. A linear motor actuator comprising:
a piston assembly comprising a shaft connected to a shaft housing at an interface region and a bobbin connected to the shaft housing and having a central axis approximately collinear with the shaft;
an actuator housing adapted to receive the piston assembly, wherein the actuator housing comprises a guide adapted to prevent the shaft from rotating; and
a detachable magnet housing adapted to connect to the actuator housing and comprising one or more magnets for actuating the piston assembly.

14. The linear motor actuator of claim 13 further comprising a linear encoder device, wherein the linear encoder device is connected to the actuator housing, and wherein the linear encoder device is adapted to track linear motion of the piston assembly.

15. The linear motor actuator of claim 14, wherein the linear encoder device is adapted to read a linear scale in order to determine the location of the piston assembly.

16. The linear motor actuator of claim 14, wherein at least one of the piston assembly, the actuator housing, the detachable magnet housing, and the linear encoder device are adapted for a snap-together assembly.

17. The linear motor actuator of claim 13, wherein the piston assembly is manufacturable in a single set-up on a lathe.

18. The linear motor actuator of claim 13, wherein the shaft comprises a spline shaft including at least one groove for interfacing with the guide.

19. The linear motor actuator of claim 13, wherein the guide comprises a spline bearing adapted to interface at least one groove formed within the shaft.

20. The linear motor actuator of claim 13, wherein the piston assembly comprises an interface for releasing the shaft from the shaft housing.

21. A method of assembling a linear motor actuator for driving a piston with a reduced lateral force, the method comprising:
providing a piston assembly comprising a shaft and a bobbin, wherein the central axis of the bobbin is approximately collinear with the shaft;
inserting at least a portion of the piston assembly within an actuator housing, wherein the actuator housing comprises a guide adapted to receive the shaft; and
connecting a magnet housing to the actuator housing, wherein the magnet housing comprises one or more magnets adapted to drive the piston assembly.

22. The method of claim 21, wherein the guide comprises a spline bearing adapted to prevent the shaft from rotating during actuation of the piston assembly.

23. The method of claim 21 further comprising attaching a linear encoder assembly to the actuator housing, wherein the linear encoder assembly is adapted to track the position of the shaft.

24. The method of claim 21 further comprising manufacturing at least one of the piston assembly, the magnet housing, and the actuator housing in a single setup on a lathe.

25. The method of claim 21, wherein the actuator housing comprises a datum for enabling assembly of the linear motor actuator within a set of predetermined tolerances.
